(19) United States
(12) Patent Application Publication
(10) Pub. No.: US 2014/0007502 A1
(43) Pub. Date: Jan. 9, 2014

(54) METHODS AND COMPOSITIONS FOR INCREASED PLANT YIELD

(71) Applicant: Willy T. Rueegg, Basel (CH)

(72) Inventor: Willy T. Rueegg, Basel (CH)

(73) Assignee: SYNGENTA PARTICIPATIONS AG, Basel (CH)

(21) Appl. No.: 14/006,227

(22) PCT Filed: Mar. 22, 2012
(86) PCT No.: PCT/EP2012/055093

§ 371 Date: Sep. 19, 2013

(30) Foreign Application Priority Data
Mar. 23, 2011 (EP) 11159309.1

(51) Int. Cl. A01N 37/42; A01G 1/00

(52) U.S. Cl. CPC A01N 37/42; A01G 1/001
USPC 47/58.1 R; 504/313

(57) ABSTRACT

A method of growing plants can comprise providing plants at a density at least 10% greater than generally recommended plant density, contacting the plants with a plant growth regulator when they have at least two true leaves, and contacting the plants with a crop-enhancing fungicide on the same day or up to 60 days later.

### FIELD OF THE INVENTION

The present invention relates to methods of increasing agricultural yields. More specifically, the invention relates to increasing the yield of crop plants through a combination of increased planting density and chemical regulation of plant response to the density increase.

### BACKGROUND OF THE INVENTION

With an estimated human population of over 9 billion in 2050 and increasing use of plant products not only as human food but also as animal feed and fuel, the requirement to increase agricultural productivity is clear. Increasing productivity, i.e., the plant yield per unit land, of current cultivated areas is one way to meet the need.

Modern agriculture has provided a number of tools to help growers increase yield. High-quality hybrid seed, pesticides, fertilisers, and mechanisation all contribute to output which is considerably higher than even 20 years ago. Some of those gains have come from increased plant density (plants per unit land).

WO 09/073211 describes how plant density reaches an ideal point, after which yields decrease. It teaches the application of the plant growth regulator cyclopropene to maize (corn) to fully or partially overcome the diminished return which results from increasing plant density.

WO 03/66576 discloses the application of phenylalanine-derivative growth regulators to inhibit vegetative growth, which is said to prevent attack by fungal disease and permit denser planting in some crops.

Despite the many advances already seen, modern agriculture demands new and inventive solutions to the challenge of increasing productivity.

### SUMMARY AND DESCRIPTION OF THE INVENTION

It is therefore an object of the invention to provide a method and compositions for increased plant yield.

According to one aspect of the present invention, there is provided a method of growing plants, comprising providing plants at a density at least 10% greater than plant density considered optimal or normally recommended by experts, contacting the plants with a plant growth regulator at day 0, and contacting the plants with the crop enhancing fungicide at day 0 to 60, wherein the plants have at least two true leaves at day 0.

According to an aspect of the present invention, the plant growth regulator can be trinexapac ethyl, chlormequat chloride, choline chloride, methasulfocarb, prohexadione calcium, 1-methylcyclopropene, antiauxins, auxins, ethylene releasers (e.g. ethephon), gibberellins (e.g. gibberellic acid), abscisic acid, jasmonic acid, prohydrojasmone or mixtures thereof.

As used herein “crop enhancing fungicide” is any fungicide which has an effect on a plant beyond that expected from fungicidal control. For example, paclobutrazol is a known growth retardant.

According to an aspect of the present invention, the crop enhancing fungicide is selected from the group consisting of a strobilurin fungicide, azole fungicide, conazole fungicide, triazole fungicide, amide fungicide, benzothiadiazole fungicide, and mixtures thereof, for example azoyxstrobin, paclobutrazol, difenoconazole, isopyrazam, epoxiconazole, acibenzolar, acibenzolar-S-methyl, or pyraclostrobin. These compounds are known, e.g. from “The Pesticide Manual”, Fifteenth Edition, Edited by Clive Tomlin, British Crop Protection Council. Alternatively, the crop enhancing fungicide of the present invention can be described by its mode of action group: nucleic acid synthesis, mitosis and cell division, respiration, amino acid and protein synthesis, signal transduction, lipid and membrane synthesis, sterol biosynthesis in membranes, glucan synthesis, melanin synthesis in cell well, host defence inducer, multi site action, or SAR (see Fungicide Resistance Action Committee, http://www.frac.info).

For ease of description, the present invention is disclosed using embodiments related to maize. However, it is contemplated that the invention could be used on a variety of commercial crops. For example, leguminous plants, such as soybeans, beans, lentils or peas; oil plants, such as sunflowers, rape, mustard, poppy or castor oil plants; sugar cane; cotton. Useful plants of elevated interest in connection with present invention are maize, soybeans, beans, peas, sunflower, oil seed rape, sugar cane, and cotton or any other typical row crops. This list does not represent any limitation.

Hybrid or transgenic plants are encompassed by the present invention. For example, glyphosate-tolerant plants are widely available as are plants modified to provide one or more traits such as drought tolerance or pest resistance. One example of a hybrid or transgenic plant is MIR604 Maize from Syngenta Seeds SAS, Chemin de l'Hobit 27, F-31 790 St. Sauveur, France, registration number C/FR/96/05/10, which has been rendered insect-resistant by transgenic expression of a modified CryIIIA toxin and may be used according to the present invention.

The plant growth regulator and crop enhancing fungicide may be formulated and applied to the crop using conventional methods. Where simultaneous application is performed, supplying the plant growth regulator and crop enhancing fungicide in the form of a twin pack or mixture may be preferred.

Formulation types include an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP), a soluble granule (SG) or any technically feasible formulation in combination with agriculturally acceptable adjuvants.

Because the plants have at least two true leaves when treated, foliar application may be preferred. Broadcast over the plants or in the rows are also suitable application methods.

Where other crop protection agents such as fertilisers or agents for controlling insect pests are to be applied to the same plants, they may be applied concomitantly in combination with the plant growth regulator and/or crop enhancing fungicide. Crop protection agents may also be applied separately, for example prior to planting as a seed treatment, during planting as an in-furrow treatment, or before or after emergence.

The amount of plant growth regulator and crop enhancing fungicide to be applied will depend on various factors, such as the compounds employed; the developmental stage of the plants treated; the planting density; the type of treatment, such as, for example spraying or dusting; and the prevailing climactic conditions.

The plant growth regulator and crop enhancing fungicide can be applied, for example, in a single “ready-mix” form, in a combined spray mixture composed from separate formulations of the single active ingredient components, such as a “tank-mix”, or as a single active ingredient applied in a sequential manner, i.e. one after the other within a period of time up to 60 days.

The application rates of plant growth regulator and crop enhancing fungicide are generally no more than those used for similar crops, controlling for geographic and climactic conditions, crop density, and application method. Lower rates may be employed.

With the combinations according to the invention it is possible to plant at a density which, compared to other modern methods, is above optimal planting density, which still increasing yield.

As used herein, “generally recommended” density or row spacing refers to that which would be considered optimum or preferred for providing a maximum economic yield based on conventional methods (those used prior to the disclosure of the present invention). Skilled persons will appreciate the general recommendation will vary depending on various factors including crop, variety, and environmental conditions such as light, moisture, and nutrient levels. One method to determine a generally recommended or conventional planting density would be to average the seed amounts sown per unit area over a period of 2, 3, 4, 5, or more years during which varieties and environmental conditions may have shown some variation. These amounts would be from years in which treatment according to the present invention was not conducted.

For example, in 2011 maize farmed in Western Europe is generally spaced in rows about 75-80 cm apart, planting approximately 70,000 seeds per hectare. In areas of maximum density farmers can space rows as closely as 35-45 cm apart. Planting up to 100,000 seeds per hectare is known; however, this does not result in an economic yield increase. This is because plants invest greater energy in increasing height, growing up to 15% taller than is seen in standard maize density. This is assumed to be due to increased competition for light. The energy spent by a plant on growing taller is thus not available for producing crop yield.

The invention encourages narrower spacing between rows and seeds than that which is currently economical, therefore existing machinery for planting and harvesting which is based on conventional spacing and is of a fixed nature may be unsuitable unless used in a new way. For example, a conventional planter could make a first pass over an area to plant seed at conventional row spacing then make a second pass over the same area, planting seeds in the second pass in rows parallel and close to the first pass rows. With equipment set for 75 cm rows, the result could be something like: five cm between rows 1 and 2, seventy cm between rows 2 and 3, five cm between rows 3 and 4, and so on.

If instead one chooses to have a single fixed row distance for an area which is narrower than conventionally used, flexible planters and harvesters are known which could be employed to allow for maximum density increase without sacrificing mechanisation. In addition to these solutions, other alternatives which may or may not provide equal row spacing fall within the scope of the present invention and could utilize existing fixed machinery or new designs.

According to an aspect of the present invention, the density is at least 10% greater than would be optimal in the absence of the plant growth regulator and crop enhancing fungicide regimen of the invention. The density may be at least 20% greater, at least 30% greater, at least 40% greater or at least 50% greater.

Plants pass through a number of developmental stages between planting of seed and harvest of the crop. Plants grown according to the inventive method are treated with plant growth regulator no earlier than the two leaf stage. Plants may be treated simultaneously with crop enhancing fungicide, or this treatment may occur in the 21 days following application of the plant growth regulator.

The BBCH scale is commonly used to indicate the stage of development of a plant at a particular point in time and will be used herein when describing maize development (Weber, E. and Bleiholder, H., Erläuterungen zu den BBCH-Dezimal-Codes für die Entwicklungsstadien von Mais, Raps, Faba-Bohne, Sonnenblume und Erbse-mit Abbildungen; Gesunde Pflanzen (1990), Vol 42, pp 308-321). Because there is some slight variation in the time plants take to reach a particular stage, the BBCH stage given corresponds to that which is most representative for the group of plants observed.

Application of the plant growth regulator may be performed during or between BBCH 12, corresponding to the two-leaf stage of leaf development, and BBCH 65, when the upper and lower parts of the tassel are in flower (male) or the stigmata are fully emerged (female), i.e. full silking. Application of the plant growth regulator may preferably be performed during or between BBCH 12 and BBCH 38, the 8 node stage of stem elongation. For example, the plant growth regulator may be applied at BBCH 12, BBCH 13, BBCH 14, BBCH 15, BBCH 16, BBCH 17, BBCH 18, BBCH 19, BBCH 20, BBCH 21, BBCH 22, BBCH 23, BBCH 24, BBCH 25, BBCH 26, BBCH 27, BBCH 28, BBCH 29, BBCH 30, BBCH 31, BBCH 32, BBCH 33, BBCH 34, BBCH 35, BBCH 36, BBCH 37, or BBCH 38.

The following data are provided by way of example and not limitation.

### Example 1

### Maize Treated with Trinexapac Ethyl and Azoxystrobin

Plots measuring 25×40 meters were planted with a common maize hybrid (Famoso, NK Seeds). Eight plots were planted according to density strategies considered optimum prior to the disclosure of the present invention: rows were spaced 75 cm apart, allowing for 16 rows per plot which had 19 cm between plants. Another eight plots were planted with maize at increased density: spacing between rows was 45 cm, giving 24 rows per plot with 22 cm between plants. Thus the density was 7 plants/m² for conventional density and 10 plants/m² for increased density.

In the 8 plots of conventional density two were untreated controls. Three were treated with a foliar application at stage BBCH 14-15; one with trinexapac ethyl, one with azoxystrobin, and one with a mixture of trinexapac and azoyxstrobin. The remaining three were treated with a foliar application at stage BBCH 31-32; one with trinexapac ethyl, one with azoxystrobin, and one with a mixture of trinexapac and azoyxstrobin. The 8 plots planted at increased density were treated at the same stages and with the same agents as for the conventional density plots. Best practices were used consistently across the test plots with regard to field conditions such as fertilisation and irrigation and all other measures like weed and insect control.

At maturity, each plot was harvested using a standard harvester. After shelling, the kernels were weighed at 14% moisture and the calculations extrapolated to a ton per hectare yield. Data are presented below in Table 1.

TABLE 1
Yields from Trinexapac Ethyl and Azoxystrobin Treatments on Maize

| Plant | | BBCH | |
|---|---|---|---|
| Density | | Stage at | Yield |
| (plants/m²) | Treatment Compound | Treatment | (tons/ha) |
| 7 | Untreated control | n/a | 16.97 |
| | Trinexapac Ethyl | 14-15 | 16.82 |
| | Azoxystrobin | 14-15 | 16.67 |
| | Trinexapac Ethyl + Azoxystrobin | 14-15 | 16.79 |
| | Trinexapac Ethyl | 31-32 | 16.70 |
| | Azoxystrobin | 31-32 | 17.28 |
| | Trinexapac Ethyl + Azoxystrobin | 31-32 | 17.31 |
| 10 | Untreated control | n/a | 19.37 |
| | Trinexapac Ethyl | 14-15 | 19.85 |
| | Azoxystrobin | 14-15 | 20.11 |
| | Trinexapac Ethyl + Azoxystrobin | 14-15 | 20.13 |
| | Trinexapac Ethyl | 31-32 | 19.41 |
| | Azoxystrobin | 31-32 | 19.58 |
| | Trinexapac Ethyl + Azoxystrobin | 31-32 | 19.83 |

As is evident from the data in Table 1, the highest yields of 20.13 t/ha were achieved by increasing plant density to 10 plants/m² and treating the maize with a mixture of trinexapac ethyl and azoxystrobin at BBCH stage 14-15. The same treatment on maize planted at conventionally accepted optimum density resulted in a yield of 16.79 t/ha. Thus the inventive method provided a nearly 20% yield increase.

### Example 2

### Maize Treated with Trinexapac Ethyl and Azoxystrobin

Plots of suitable size in Valais, Switzerland were planted with maize hybrid COOLER™ (NK Seeds) at a conventional amount of seeds per hectare (in this example, 99,000) and at an increased density amount of seeds per hectare (in this example, 125,000).

Each density area was divided into four separate treatments—an untreated control, treatment with trinexapac ethyl (0.6 l/Ha of MODDUS™ 250EC which has 250 g trinexapac ethyl per liter) at BBCH 14, treatment with azoyxstrobin (1 l/Ha of a formulated product having 141.4 g azoxystrobin per liter in the form of QUILT® (Syngenta Crop Protection AG) which also contains 122.4 g propiconazole per liter) at BBCH 14, and treatment with trinexapac ethyl (0.6 l/Ha of 250 g/l product) and azoxystrobin (1 l/Ha of 141.4 g/l product) at BBCH 14.

Best practices were used consistently across the test plots with regard to field conditions such as fertilisation and irrigation and all other measures like weed and insect control. There was no fungal disease pressure. After a growing season of 188 days (29 Apr. 2011 to 3 Nov. 2011), each plot was harvested using a standard harvester. After shelling, the kernels were weighed at 14% moisture and the calculations extrapolated to a ton per hectare yield. Data are presented below in Table 2.

TABLE 2
Yields from Trinexapac Ethyl and Azoxystrobin Treatments on Maize

| Seeds per | | |
|---|---|---|
| Hectare | Treatment Compound | Yield (tons/ha) |
| 99,000 | Untreated control | 14.1 |
| | Trinexapac Ethyl | 14.0 |
| | Azoxystrobin | 14.1 |
| | Trinexapac Ethyl + Azoxystrobin | 14.6 |
| 125,000 | Untreated control | 17.4 |
| | Trinexapac Ethyl | 18.6 |
| | Azoxystrobin | 17.8 |
| | Trinexapac Ethyl + Azoxystrobin | 17.8 |

As is evident from the data in Table 2, increasing planting density provided an increase in yield for the untreated control. However, above and beyond this benefit we see that the high density treatment groups all had further increases in yield. Depending on commodity prices, this increased yield could be many times over the incremental cost associated with the treatments. Regardless of economic concerns, if employed over a piece of farmland it would allow for increase in production without increasing the surface area required.

### Example 3

### Maize Treated with Trinexapac Ethyl and Azoxystrobin

Plots were prepared and treated according to the procedure described in Example 2. The differences were that the location was Milano, Italy and the variety was Famoso (NK Seeds). The growing season was 163 days (18 Apr. 2011 to 28 Sep. 2011). Data are presented below in Table 3.

TABLE 3
Yields from Trinexapac Ethyl and Azoxystrobin Treatments on Maize

| Seeds per | | |
|---|---|---|
| Hectare | Treatment Compound | Yield (tons/ha) |
| 73,000 | Untreated control | 10.8 |
| | Trinexapac Ethyl | 11.3 |
| | Azoxystrobin | 11.6 |
| | Trinexapac Ethyl + Azoxystrobin | 11.8 |
| 94,000 | Untreated control | 11.5 |
| | Trinexapac Ethyl | 12.1 |
| | Azoxystrobin | 12.2 |
| | Trinexapac Ethyl + Azoxystrobin | 11.8 |

As is evident from the data in Table 3, the increased planting density allowed for higher yields than seen from the conventional density or even increased density plantings which were untreated control. Without wanting to be bound by theory, for the 94,000 seeds/Ha plantings, the higher yields seen for plants treated with either trinexapac ethyl or azoxystrobin as compared to the combination treatment of both ingredients is believed to be due to a stress-mitigating influence of these compounds. The combination treatment of trinexapac ethyl and azoxystrobin is similar for the 2 densities, suggesting there is a correlation to the physiological stage at harvest. The maize planted at higher density had higher grain humidity and was not fully ripened, therefore the grains were not fully developed and the yield potential not reached, even though they show higher yields than normal planting

### Example 4

### Maize Treated with Trinexapac Ethyl and Azoxystrobin

Plots were prepared and treated according to the procedure described in Example 2. The differences were that the location was Oise, France and the variety was Terada (NK Seeds). The growing season was 182 days (14 Apr. 2011 to 13 Oct. 2011). Data are presented below in Table 4.

TABLE 4
Yields from Trinexapac Ethyl and Azoxystrobin Treatments on Maize

| Seeds per | | |
|---|---|---|
| Hectare | Treatment Compound | Yield (tons/ha) |
| 70,000 | Untreated control | 11.3 |
| | Trinexapac Ethyl | 10.5 |
| | Azoxystrobin | 11.2 |
| | Trinexapac Ethyl + Azoxystrobin | 10.9 |
| 100,000 | Untreated control | 14.5 |
| | Trinexapac Ethyl | 14.6 |
| | Azoxystrobin | 13.6 |
| | Trinexapac Ethyl + Azoxystrobin | 14.1 |

As is evident from the data in Table 4, the increased planting density allowed for higher yields than seen from the conventional density. Without wanting to be bound by theory, the unexpectedly high yield in high density planting untreated control is believed to be due to the high density of plants, which to some extent masked the impact of the crop enhancing effects of trinexapac ethyl and azoxystrobin.

### Example 5

### Maize Treated with Trinexapac Ethyl and Azoxystrobin

Plots were prepared and treated according to the procedure described in Example 2. The differences were that the location was Milano, Italy and the variety was Famoso (NK Seeds). The growing season was 158 days (15 Apr. 2011 to 20 Sep. 2011). Data are presented below in Table 5.

TABLE 5
Yields from Trinexapac Ethyl and Azoxystrobin Treatments on Maize

| Seeds per | | |
|---|---|---|
| Hectare | Treatment Compound | Yield (tons/ha) |
| 74,000 | Untreated control | 14.6 |
| | Trinexapac Ethyl | 13.7 |
| | Azoxystrobin | 14.0 |
| | Trinexapac Ethyl + Azoxystrobin | 14.1 |
| 94,000 | Untreated control | 15.6 |
| | Trinexapac Ethyl | 14.7 |
| | Azoxystrobin | 15.0 |
| | Trinexapac Ethyl + Azoxystrobin | 14.7 |

As is evident from the data in Table 5, the increased planting density allowed for higher yields than seen from the conventional density or even increased density plantings which were untreated control. Without wanting to be bound by theory, the high yield of the control groups compared to the test compounds is believed to be due to the lack of stress factors in the particular conditions at application. Additionally, the high density variants overall were less mature at harvest than the conventional planting density crop which could differentiate the variants.

### Example 6

### Maize Treated with Trinexapac Ethyl and Azoxystrobin

Plots were prepared and treated according to the procedure described in Example 2. The differences were that the location was Niedersachsen, Germany and the variety was DeliTop (NK Seeds). The growing season was 184 days (1 May 2011 to 1 Nov. 2011). Data are presented below in Table 6.

TABLE 6
Yields from Trinexapac Ethyl and Azoxystrobin Treatments on Maize

| Seeds per | | |
|---|---|---|
| Hectare | Treatment Compound | Yield (tons/ha) |
| 72,000 | Untreated control | 11.4 |
| | Trinexapac Ethyl | 11.4 |
| | Azoxystrobin | 11.4 |
| | Trinexapac Ethyl + Azoxystrobin | 10.9 |
| 111,000 | Untreated control | 10.6 |
| | Trinexapac Ethyl | 11.0 |
| | Azoxystrobin | 11.1 |
| | Trinexapac Ethyl + Azoxystrobin | 11.7 |

As is evident from the data in Table 6, the increased planting density and dual treatment system produced the highest yields.

The complete set of raw data including information such as planting and harvest dates, local environmental conditions during the growing season, and varieties used was analysed. It is evident that the present invention may be exploited to its full potential by bearing in mind certain factors.

Higher density planting may cause slightly longer maturation times so ensuring all variables are selected so that a crop will be able to reach full maturity during the growing season may provide the best results. For example, when planting maize one can choose a slightly hardier variety than otherwise would be used in an area. Where a maturity class 6 variety might be standard, switching to a maturity class 5 or even 4 variety could reap the most benefits from the inventive system. For one, this would facilitate earlier planting. Also, the variety could experience a longer than typical maturation time (due to high planting density) yet still reach full maturity in the normal growing season.

Higher density planting can require additional inputs over conventional planting systems. Particularly in hot, dry areas, increasing irrigation may provide significantly improved results.

1. A method of growing plants comprising:
providing plants at a density at least 10% greater than generally recommended plant density;
contacting the plants with a plant growth regulator at day 0; and
contacting the plants with the crop-enhancing fungicide at day 0 to 60, wherein the plants have at least two true leaves at day 0.

2. A method of growing plants according to claim 1, wherein the plant growth regulator is selected from the group consisting of trinexapac ethyl, chlormequat chloride, choline chloride, methasulfocarb, prohexadione calcium, 1-methylcyclopropene, antiauxins, auxins, ethylene releasers, ethephon, gibberellins, gibberellic acid, abscisic acid, jasmonic acid, prohydrojasmone or mixtures thereof.

3. A method of growing plants according to claim 2, wherein the plant growth regulator is trinexapac ethyl.

4. A method of growing plants according to claim 1, wherein the crop-enhancing fungicide is selected from the group consisting of a strobilurin fungicide, azole fungicide, conazole fungicide, triazole fungicide, amide fungicide, benzothiadiazole fungicide and mixtures thereof.

5. A method of growing plants according to claim 4, wherein the crop-enhancing fungicide is selected from the group consisting of azoyxstrobin, paclobutrazol, difenoconazole, isopyrazam, epoxiconazole, acibenzolar, acibenzolar-S-methyl, or pyraclostrobin.

6. A method of growing plants according to claim 5, wherein the crop-enhancing fungicide is azoxystrobin.

7. A method of growing plants according to claim 1, wherein the density is at least 20%, preferably at least 30%, more preferably at least 40%, even more preferably at least 50% greater than generally recommended plant density.

8. A method according to claim 1, wherein the plants have a lower maturity group than a maturity group recommended for optimum growth in a location where the plants are provided.

9. A method of growing plants according to claim 1, wherein the plants are crop plants conventionally grown in rows.

10. A method of growing plants according to claim 9, wherein the plants are selected from the group consisting of maize, soybeans, beans, peas, sunflower, oil seed rape, sugar cane, and cotton.

11. A method of growing plants according to claim 10 wherein the plants are maize and the maize is planted at a density of at least approximately 9 plants/m², for example 9 plants/m², 10 plants/m², 11 plants/m², 12 plants/m² or 13 plants/m².

12. A method of growing plants according to claim 11, wherein the maize is contacted with the plant growth regulator at stage BBCH 12 to 65, preferably at stage BBCH 12 to 38.

13. A method of growing plants according to claim 11, wherein the maize is contacted with the crop-enhancing fungicide at stage BBCH 30 to 65.

14. A method of growing plants according to claim 11, wherein the maize is a variety selected from the group consisting of COOLER, Famoso, Terada, and DeliTop.

15. A method of achieving desired yield in crop plants grown in rows comprising:
providing crop plants in rows wherein at least half of the rows are spaced at a distance at least 10% less than generally recommended row distance;
contacting the crop plants with a plant growth regulator at day 0;
contacting the crop plants with the crop-enhancing fungicide at day 0 to 60; and
harvesting the crop plants to provide a yield, wherein
the plants have at least two true leaves at day 0.

16. A method of achieving desired yield according to claim 15, wherein the plant growth regulator is selected from the group consisting of trinexapac ethyl, chlormequat chloride, choline chloride, methasulfocarb, prohexadione calcium, 1-methylcyclopropene, antiauxins, auxins, ethylene releasers, ethephon, gibberellins, gibberellic acid, abscisic acid, jasmonic acid, prohydrojasmone or mixtures thereof.

17. A method of achieving desired yield according to claim 15, wherein the crop-enhancing fungicide is selected from the group consisting of a strobilurin fungicide, azole fungicide, conazole fungicide, triazole fungicide, amide fungicide, benzothiadiazole fungicide and mixtures thereof.

18. A method of achieving desired yield according to claim 16, wherein the crop-enhancing fungicide is selected from the group consisting of azoyxstrobin, paclobutrazol, difenoconazole, isopyrazam, epoxiconazole, acibenzolar, acibenzolar-S-methyl, or pyraclostrobin.

19. A method of achieving desired yield according to claim 15, wherein the row distance is at least 20% less, at least 30% less, at least 40% less, or at least 50% less than generally recommended row distance.

20. A method of achieving desired yield according to claim 15, wherein the crop plants are maize and the row distance is less than 60 cm, preferably less than 50 cm.
